(19) United States
(12) Patent Application Publication
(10) Pub. No.: US 2019/0114065 A1
(43) Pub. Date: Apr. 18, 2019

(54) METHOD FOR CREATING PARTIAL SCREENSHOT

(71) Applicant: GETAC TECHNOLOGY CORPORATION, HSINCHU COUNTY (TW)

(72) Inventors: Hsuan-Wei Tsao, Taipei City (TW); Jiunn-Jye Lee, Taipei City (TW)

(21) Appl. No.: 15/786,528

(22) Filed: Oct. 17, 2017

(51) Int. Cl. G06F 3/0488; G06F 3/0484

(52) U.S. Cl. CPC G06F 3/04883; G06F 2203/04104; G06F 3/04842; G06F 3/04847

(57) ABSTRACT

A method for creating partial screenshot includes displaying a screen frame on touch surface of a display unit, sensing a multi-touch gesture on the touch surface, acquiring a plurality of pixels on the screen frame according to a plurality of coordinate positions of the multi-touch gesture, defining a captured region according to the pixels, and creating a partial screenshot according to the screen frame and the captured region.

### BACKGROUND OF THE INVENTION

### Field of the Invention

The present invention relates to screen capture technologies and, more particularly, to a method for capturing a partial screenshot.

### Description of the Prior Art

Handheld devices, such as smartphones and tablets, are gradually integrated into people's lives, because of technology advances and wide use of the Internet, and have various uses for people's lives, including inquiries, navigation, shopping, payment, listening to music, and reading, when operated by related applications (apps), respectively.

Handheld device users take screenshots on handheld devices by a screen capturing function thereof to capture data shown on the screens of the handheld devices and found by the users to be attractive or important, regardless of the types of applications (for example, browser apps, navigation apps, and shopping website apps) running on the handheld devices. However, to remove unnecessary regions (regions not containing data attractive or important to the users) from the screenshots, the users have to adjust the dimensions of the screenshots with photo-editing software.

Wider use of the Internet causes handheld device users' growing exposure to foreign languages. However, use of conventional translation applications has a drawback described below. Users confronted with a text presented in a foreign language have to memorize or write down the text in the foreign language, and then enter the text to a translation program or translation webpage with a view to translating the text from the foreign language into the users' native languages. Alternatively, the users take screenshots on their handheld devices by a screen capturing function thereof to capture images of the text in the foreign language, then perform optical recognition on the screenshots with a text recognition program to retrieve all the text data of the screenshots, and finally enter the retrieved text data to a translation program or translation webpage with a view to translating the text from the foreign language into the users' native languages.

### SUMMARY OF THE INVENTION

In an embodiment, a method for capturing a partial screenshot, comprising the steps of: displaying a screen frame on a touch surface of a display unit; detecting a multi-touch gesture on the touch surface; identifying a plurality of pixels on the screen frame according to a plurality of coordinate positions of the multi-touch gesture; defining a captured region according to the pixels; and capturing a partial screenshot according to the screen frame and the captured region.

In some embodiments, the method for capturing a partial screenshot further comprises the step of recognizing optical features of the partial screenshot.

In some embodiments, the multi-touch gesture consists of consecutive taps at the coordinate positions and at least another held tap at the coordinate positions or consists of consecutive taps at the coordinate positions.

In some embodiments, the pixels are located at vertices of the captured region, respectively.

In some embodiments, the displaying step comprises displaying the screen frame on the touch surface of the display unit by execution of an application.

In some embodiments, the detecting step is performed in a background of an operating system.

In conclusion, a method for capturing a partial screenshot according to the present invention enables a partial screenshot to be captured according to coordinate positions of a multi-touch gesture without taking a full screen frame to therefore capture easily and quickly the partial screenshot of a desktop or execution frame for any application (app) on the touch device. The method for capturing a partial screenshot according to the present invention further enables optical feature recognition to be automatically performed on the captured partial screenshot so as to directly identify text data therein.

### BRIEF DESCRIPTION OF THE DRAWINGS

FIG. 1 is a schematic view of a process flow of a method for capturing a partial screenshot according to an embodiment of the present invention;

FIG. 2 is a block diagram of a touch device for use with the method depicted in FIG. 1;

FIG. 3 is a schematic view of an electronic device of FIG. 2 according to an embodiment of the present invention;

FIG. 4 is a schematic view of a captured region mentioned in step S04 of FIG. 1 according to an embodiment of the present invention; and

FIG. 5 is a schematic view of a partial screenshot mentioned in step S05 of FIG. 1 according to an embodiment of the present invention.

### DETAILED DESCRIPTION OF THE EMBODIMENTS

A method for capturing a partial screenshot according to the present invention is applicable to an electronic device (hereinafter referred to as the touch device) with a touch function. In some embodiments, the method for capturing a partial screenshot according to the present invention is implemented using a computer program product. In some embodiments, the computer program product is a readable record medium which stores a program composed of codes so that the method for capturing a partial screenshot according to any embodiment of the present invention is carried out after the touch device has loaded and executed the program. In some embodiments, the program itself is a computer program product which is transmitted to the touch device wiredly or wirelessly. In some embodiments, the program is preferably a background program.

In some embodiments, the touch device is a handheld device or a non-handheld device. The handheld device is, for example, a smartphone, a portable navigation device (PND), an e-book, a notebook computer, or a tablet computer (tablet or pad). The non-handheld device is, for example, a smart home appliance, a digital billboard, or a multimedia kiosk (MMK).

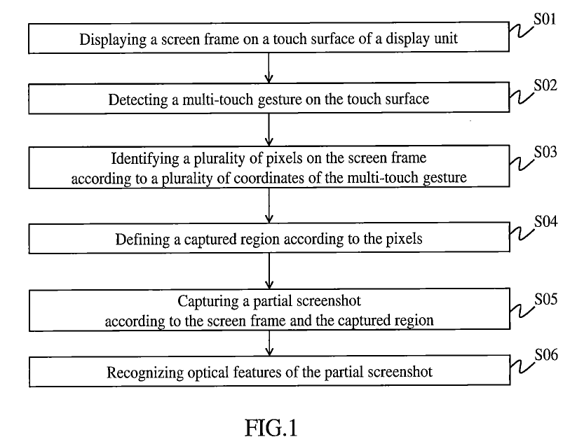

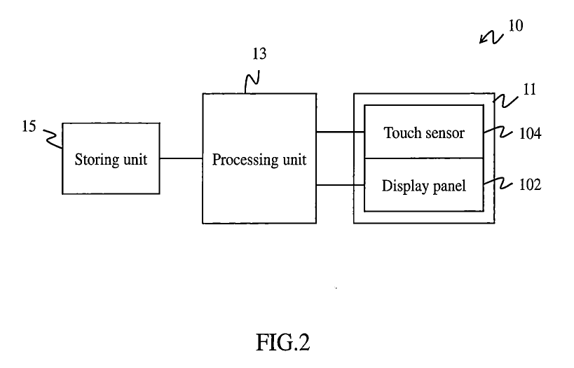

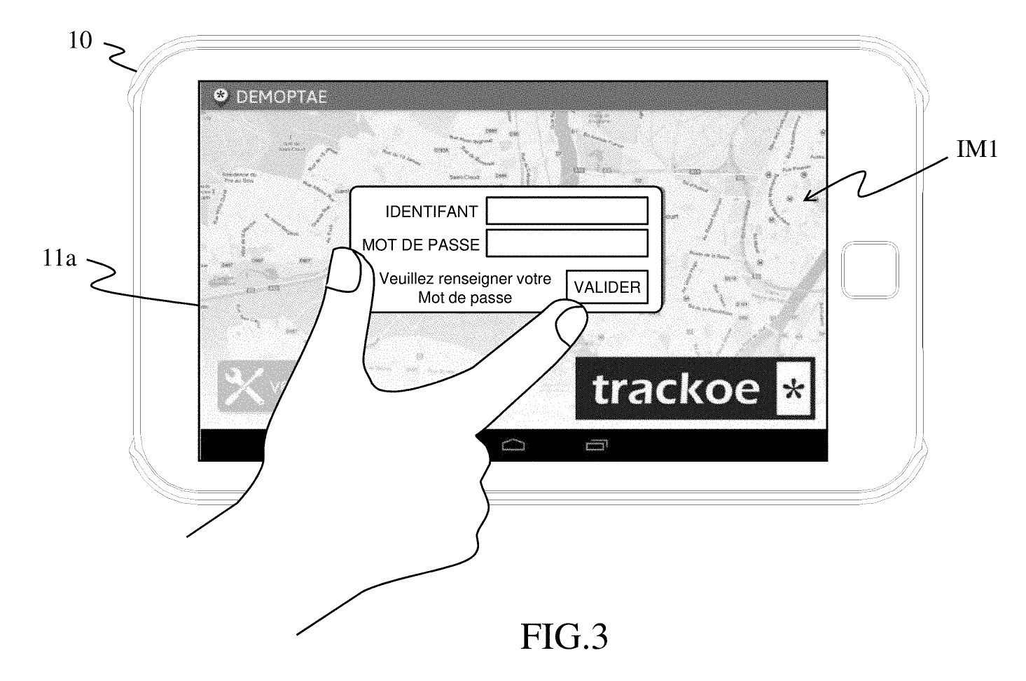

FIG. 1 is a schematic view of a process flow of a method for capturing a partial screenshot according to an embodiment of the present invention. FIG. 2 is a block diagram of a touch device for use with the method depicted in FIG. 1. FIG. 3 is a schematic view of an electronic device of FIG. 2 according to an embodiment of the present invention.

Referring to FIG. 2, in some embodiments, a touch device 10 comprises a display unit 11, a processing unit 13 and a storing unit 15. The processing unit 13 is coupled to the display unit 11 and the storing unit 15. The processing unit 13 controls the operation of the other components, such as the display unit 11 and the storing unit 15. The storing unit 15 stores a program for implementing the method for capturing a partial screenshot according to any embodiment of the present invention as well as data and/or parameters for use in the course of the implementation of the method. In some embodiments, the display unit 11 is a touch display unit which comprises a display panel 102 and a touch sensor 104. For instance, the touch sensor 104 and the display panel 102 overlap so that a sensing surface of the touch sensor 104 is in contact with a display surface of the display panel 102 to jointly form a touch surface 11a.

Referring to FIG. 1 through FIG. 3, in response to a program running on the processing unit 13, a screen frame IM1 is shown on the touch surface 11 a of the display unit 11 (step S01), and the processing unit 13 detects a multi-touch gesture on the touch surface 11 a (step S02).

In some embodiments, the screen frame IM1 is an execution frame for any application (app) or an execution frame (such as a desktop) of an operating system. For instance, when the touch device 10 is functioning well, the processing unit 13 runs an operating system or any application, whereas the current execution frame of the operating system or application is shown on the touch surface 11 a of the display unit 11. In some embodiments, the application is a browser APP, a navigation app or a shopping website app.

In some embodiments of step S02, the touch sensor 104 senses a touch event on the touch surface 11 a and identifies coordinate positions of a touch point indicative of the occurrence of the touch event, and then the processing unit 13 determines a multi-touch gesture according to the quantity of the identified coordinate positions and changes in the identified coordinate positions over a continuous time period. In some embodiments of the determination step S02, at any point in time, there are multiple touch points (coordinate positions) whereby the processing unit 13 determines a multi-touch gesture. Two examples of the aforesaid situation are described as follows: first, multiple coordinate positions are identified at any point in time (that is, there are multiple touch points at the same point in time), and the coordinate position of at least one of the touch points changes over a continuous time period; second, there are multiple touch points at any point in time, and the touch points are not at the same coordinate position over a continuous time period.

In an embodiment, the multi-touch gesture consists of consecutive taps at multiple coordinate positions and at least another held tap at multiple coordinate positions. Therefore, as exemplified by two consecutive taps, at the first point in time over a continuous time period the processing unit 13 detects multiple touch points (for example, two touch points, hereinafter referred to as the first touch point and the second touch point) and identifies the coordinate positions of the touch points. At the second point in time which follows the first point in time, the processing unit 13 detects the disappearance of the first touch point and the ongoing presence of the second touch point. At the third point in time which follows the second point in time, the processing unit 13 detects the reappearance of the first touch point and the ongoing presence of the second touch point.

In another embodiment, the multi-touch gesture consists of consecutive taps at multiple coordinate positions. Therefore, as exemplified by two consecutive taps, at the first point in time over a continuous time period the processing unit 13 detects multiple touch points and identifies the coordinate positions of the touch points. At the second point in time which follows the first point in time, the processing unit 13 detects the disappearance of the touch points (at the same coordinate position). At the third point in time which follows the second point in time, the processing unit 13 detects the reappearance of the touch points (at the same coordinate position.)

In yet another embodiment, the multi-touch gesture consists of movement of multiple touch points from the first coordinate positions to the second coordinate positions, respectively, allowing the first and second coordinate positions of the same touch point to differ.

In some embodiments, the consecutive taps occur at least twice, for example, twice, three times, four times, or more. In this regard, the number of consecutive taps is adjustable as needed.

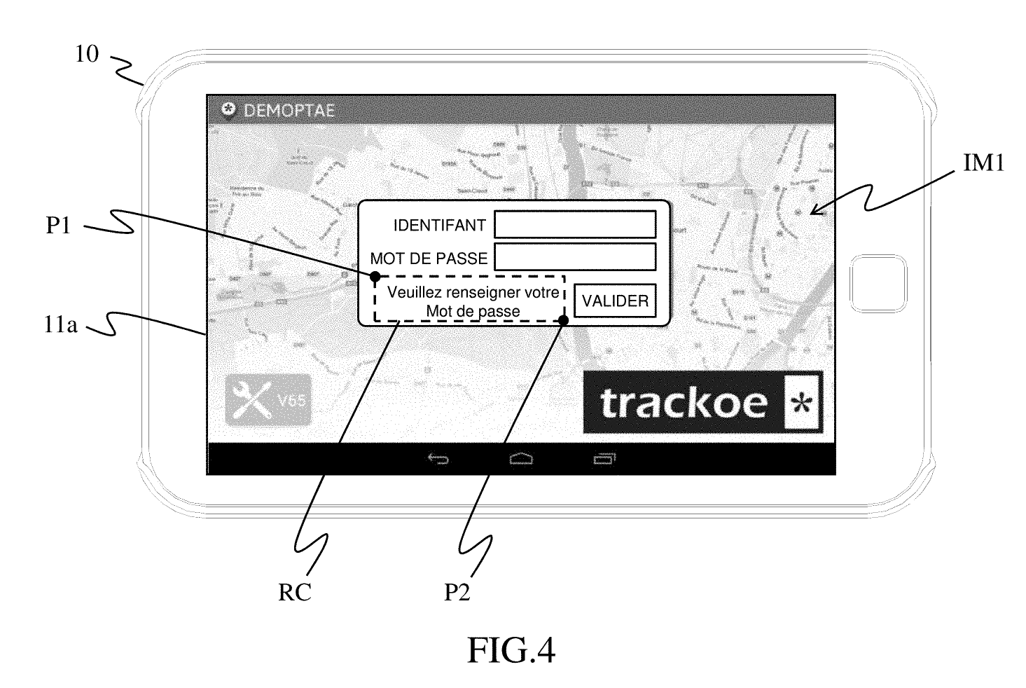

Referring to FIG. 4, upon detection of a multi-touch gesture (step S02), the processing unit 13 identifies a plurality of pixels P1, P2 on the screen frame IM1 according to a plurality of coordinate positions of the multi-touch gesture (step S03) and defines a captured region RC according to the identified pixels P1, P2 (step S04).

In an embodiment, the identified pixels P1, P2 are located at the border of the captured region RC. In another embodiment, the identified pixels P1, P2 are located at the vertices of the captured region RC, respectively. In some embodiments, the captured region RC is a circle, an ellipse or a polygon. For instance, when the captured region RC is a rectangle, the pixels P1, P2 are located at two opposite vertices of the captured region RC, respectively.

In some embodiments, although FIG. 4 depicts the captured region RC for an exemplary purpose, in practice the identified pixels P1, P2 and the defined captured region RC are parameters obtained by the backend operation of the processing unit 13 but not displayed on the processing unit 13.

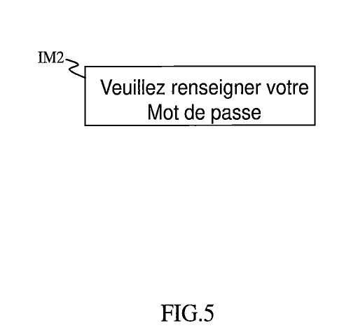

After defining the captured region RC (step S04), the processing unit 13 captures a partial screenshot IM2 (shown in FIG. 5) according to the screen frame IM1 and the captured region RC (step S05). After capturing the partial screenshot IM2, the processing unit 13 stores the partial screenshot IM2 in the storing unit 15.

In an embodiment of step S05, the processing unit 13 captures the partial screenshot IM2 according to the screen frame IM1 and the captured region RC without taking a full screen frame. In another embodiment of step S05, the processing unit 13 takes a full screen frame (background processing file) of the screen frame IM1 at the backend and then cuts the full screen frame according to the captured region RC, so as to obtain the partial screenshot IM2. Therefore, from a user's perspective, the touch device 10 finally produces the partial screenshot IM2 but not a screenshot of the full screen frame of the screen frame IM1.

In some embodiments, after capturing the partial screenshot IM2 (step S05), the processing unit 13 generates and displays a notification message on the display unit 11 to notify a user of the touch device 10 of the capture of the partial screenshot IM2 so that the user selects the notification message or accesses a photo management program of the touch device 10 to look at the captured partial screenshot IM2. In some embodiments, the processing unit 13 displays the notification message on the display unit 11 by a push technology, and thus the notification message is a push message.

In some embodiments, after capturing the partial screenshot IM2 (step S05), the processing unit 13 further performs optical feature recognition on the partial screenshot IM2 to obtain text-like text data presented on the partial screenshot IM2 (step S06). As exemplified by the partial screenshot IM2 shown in FIG. 5, the processing unit 13 performs optical feature recognition on the partial screenshot IM2 to obtain text data “Veuillez renseigner votre Mot de passe.” The processing unit 13 performs optical feature recognition on the partial screenshot IM2 by an optical feature recognition technology. The optical feature recognition technology is well known among persons skilled in the art and therefore is not described herein.

In some embodiments, after the text data has been obtained (step S06), the user operates the touch device 10 to copy the text data for subsequent use. Three examples of the aforesaid situation are described as follows: first, copy and paste the text data to a translation program or translation webpage whereby the text data is translated from a first language into a second language; second, copy and paste the text data to a word processing program to compile a document; third, copy and paste the text data to a chat program or social networking program to post the text data.

In some embodiments, the processing unit 13 is a microprocessor, a microcontroller, a digital signal processor, a microcomputer or a central processor. The storing unit 15 is implemented by one or more storing components. The storing components are, for example, memory or register, but the present invention is not limited.

In conclusion, a method for capturing a partial screenshot according to the present invention enables a partial screenshot to be captured according to coordinate positions of a multi-touch gesture without taking a full screen frame to therefore capture easily and quickly the partial screenshot of a desktop or execution frame for any application on the touch device. The method for capturing a partial screenshot according to the present invention further enables optical feature recognition to be automatically performed on the captured partial screenshot so as to directly identify text data therein.

What is claimed is:

1. A method for capturing a partial screenshot, comprising the steps of:
displaying a screen frame on a touch surface of a display unit;
detecting a multi-touch gesture on the touch surface;
identifying a plurality of pixels on the screen frame according to a plurality of coordinate positions of the multi-touch gesture;
defining a captured region according to the pixels; and
capturing a partial screenshot according to the screen frame and the captured region.

2. The method for capturing a partial screenshot according to claim 1, further comprising the step of recognizing optical features of the partial screenshot.

3. The method for capturing a partial screenshot according to claim 1, wherein the multi-touch gesture consists of consecutive taps at the coordinate positions and at least another held tap at the coordinate positions.

4. The method for capturing a partial screenshot according to claim 1, wherein the multi-touch gesture consists of consecutive taps at the coordinate positions.

5. The method for capturing a partial screenshot according to claim 1, wherein the pixels are located at vertices of the captured region, respectively.

6. The method for capturing a partial screenshot according to claim 1, wherein the displaying step comprises displaying the screen frame on the touch surface of the display unit by execution of an application.

7. The method for capturing a partial screenshot according to claim 1, wherein the detecting step is performed in a background of an operating system.

8. The method for capturing a partial screenshot according to claim 1, wherein the screen frame is an execution frame for an operating system.

9. The method for capturing a partial screenshot according to claim 1, wherein the screen frame is an execution frame for an application.
